(19) United States
(12) Patent Application Publication
(10) Pub. No.: US 2024/0079552 A1
(43) Pub. Date: Mar. 7, 2024

(54) ELECTRODE, BATTERY, AND METHOD FOR PRODUCING ELECTRODE

(71) Applicant: TOYOTA JIDOSHA KABUSHIKI KAISHA, Toyota-shi Aichi-ken (JP)

(72) Inventors: Masashi UEDA, Toyota-shi Aichi-ken (JP); Shinji Kojima, Nagoya-shi Aichi-ken (JP); Takuo Yanagi, Toyota-shi Aichi-ken (JP); Sokichi Okubo, Okazaki-shi Aichi-ken (JP)

(73) Assignee: TOYOTA JIDOSHA KABUSHIKI KAISHA, Toyota-shi Aichi-ken (JP)

(21) Appl. No.: 18/381,201

(22) Filed: Oct. 18, 2023

(30) Foreign Application Priority Data
Apr. 11, 2022 (JP) 2022-177244

(51) Int. Cl. H01M 4/131; H01M 4/04; H01M 4/1391; H01M 4/36; H01M 4/62; H01M 10/0525

(52) U.S. Cl. CPC H01M 4/131; H01M 4/0404; H01M 4/1391; H01M 4/366; H01M 4/623; H01M 10/0525

(57) ABSTRACT

An electrode to be used for a battery, the electrode including: a current collector, a first electrode layer arranged on the current collector, and a second electrode layer arranged on the first electrode layer, wherein the first electrode layer includes a first active material, and a first binder covering a surface of the first active material; the second electrode layer includes a second active material, and a second binder covering a surface of the second active material; and when C₁ (%) designates a coverage of the first binder with respect to the first active material, and C₂ (%) designates a coverage of the second binder with respect to the second active material, the C₁ is larger than the C₂.

### CROSS-REFERENCE TO RELATED APPLICATIONS

This application is based upon and claims the benefit of priority of the prior Japanese Patent Application No. 2022-177244, filed on Nov. 4, 2022, the entire contents of which are incorporated herein by reference.

### TECHNICAL FIELD

The present disclosure relates to an electrode, a battery, and a method for producing an electrode.

### BACKGROUND ART

In recent years, accordance with the rapid spread of electronic apparatus such as a personal computer and a portable telephone, the development of a battery used for the power source thereof has been advanced. Also, in the automobile industry, the development of a battery used for hybrid electric vehicles (HEV), plug-in hybrid electric vehicles (PHEV), or battery electric vehicles (BEV) has been advanced. Among various batteries, a lithium ion secondary battery has an advantage of high energy density.

A battery represented by the lithium ion secondary battery usually comprises a cathode, an anode, and an electrolyte layer arranged between the cathode and the anode. The cathode usually includes a cathode current collector, and a cathode layer containing a cathode active material. Also, the anode usually includes an anode current collector, and an anode layer containing an anode active material.

Patent Literature 1 discloses a multi-layered electrode structure body in which electrode layers including a binder configured by at least a polymer, and an electrode material are layered on a current collector, wherein a first electrode layer arranged to contact a current collecting material has a different material composition or a different blending ratio from that of a second electrode layer arranged on the first electrode layer.

Patent Literature 2 discloses a separation film interposed between a cathode and an anode of a lithium battery, the separation film comprising a base material, a first layer and a second layer arranged on an entire surface of the base material, wherein different kind of binders are used in the first layer and the second layer.

Patent Literature 3 discloses a method for producing an electrode for a secondary battery, the method comprising: a step of pasting a slurry for first layer on a surface of a current collector, a step of pasting a slurry for second layer on the slurry for first layer before the slurry for first layer is dried, and a step of obtaining a layered structure in which layers in the order of a first layer and a second layer are layered on the current collector, by drying the slurry for first layer and the slurry for second layer after pasting the slurry for first layer and the slurry for second layer, wherein the first layer is an active material layer, the second layer is an insulating layer not containing an active material, and different kind of binders make viscosity of the slurries different.

Patent Literature 4 discloses an electrode for lithium ion secondary battery comprising a current collector and an electrode layer, wherein the electrode layer includes a first electrode layer and a second electrode layer of which binder resin concentration is higher than a binder resin concentration of the first electrode layer.

### CITATION LIST

### Patent Literatures

Patent Literature 1: Japanese Patent Application Laid-Open (JP-A) No. 2001-307716
Patent Literature 2: JP-A No. 2020-136276
Patent Literature 3: JP-A No. 2019-096501
Patent Literature 4: International Application Publication: WO 2011/142083

### SUMMARY OF DISCLOSURE

### Technical Problem

Inventors of the present disclosure have thoroughly researched and found out that the capacity durability may be degraded when the battery is stored under high temperature (such as at 60° C.). This is presumably because a binder in the electrode layer is swelled by the liquid electrolyte during high temperature storage to degrade the bonding force of the electrode layer, and the electron conductivity in the interface between the current collector and the electrode layer is degraded. Meanwhile, when the binder amount in the electrode layer is increased, although the degrade in capacity durability during high temperature storage is suppressed, resistance increase rate during high temperature becomes large.

The present disclosure has been made in view of the above circumstances, and a main object thereof is to provide an electrode capable of inhibiting the increase of resistance increase rate while restraining the degrade of capacity durability during high temperature storage.

### Solution to Problem

[1]

An electrode to be used for a battery, the electrode comprising:
a current collector, a first electrode layer arranged on the current collector, and a second electrode layer arranged on the first electrode layer, wherein
the first electrode layer includes a first active material, and a first binder covering a surface of the first active material;
the second electrode layer includes a second active material, and a second binder covering a surface of the second active material; and
when C₁ (%) designates a coverage of the first binder with respect to the first active material, and C₂ (%) designates a coverage of the second binder with respect to the second active material, the C₁ is larger than the C₂.

[2]

The electrode according to [1], wherein the C₁ is larger than 50%, and the C₂ is 50% or less.

[3]

The electrode according to [1] or [2], wherein a difference between the C₁ and the C₂ is 30% or more.

[4]

The electrode according to any one of [1] to [3], wherein the first binder and the second binder are a fluorine-containing binder.

[5]

The electrode according to any one of [1] to [4], wherein the first binder and the second binder have the same composition.

[6]

The electrode according to any one of [1] to [5], wherein the first active material and the second active material are a lithium transition metal composite oxide.

[7]

The electrode according to any one of [1] to [6], wherein the first active material and the second active material have the same composition.

[8]

The electrode according to any one of [1] to [7], wherein the first electrode layer contains a first composite body in which the first binder and a first conductive material are dispersed on a surface of the first active material; and
the second electrode layer contains a second composite body in which the second binder and a second conductive material are dispersed on a surface of the second active material.

[9]

A battery including a cathode, an anode, and an electrolyte layer arranged between the cathode and the anode, wherein at least one of the cathode and the anode is the electrode according to any one of [1] to [8].

The battery according to [9], wherein the battery is a lithium ion battery.

A method for producing an electrode to be used for a battery, the method comprising:
a first layer forming step of forming a first electrode layer on a current collector, using a first electrode mixture containing a first active material and a first binder covering a surface of the first active material, by a dry method; and
a second layer forming step of forming a second electrode layer on the first electrode layer, using a second electrode mixture containing a second active material and a second binder covering a surface of the second active material, by a dry method; and
when C₁ (%) designates a coverage of the first binder with respect to the first active material, and C₂ (%) designates a coverage of the second binder with respect to the second active material, the C₁ is larger than the C₂.

### Effects of Disclosure

The electrode in the present disclosure exhibits an effect of inhibiting the increase of resistance increase rate while restraining the degrade of capacity durability during high temperature storage.

### BRIEF DESCRIPTION OF DRAWINGS

FIG. 1 is a schematic cross-sectional view exemplifying the electrode in the present disclosure.

FIG. 2A is a schematic plan view exemplifying the electrode in the present disclosure.

FIG. 2B is a schematic cross-sectional view exemplifying the electrode in the present disclosure.

FIG. 3 is a schematic cross-sectional view exemplifying the battery in the present disclosure.

FIG. 4 is a flow chart exemplifying the method for producing the electrode in the present disclosure.

FIG. 5 is a binarized image explaining a method for calculating the coverage of binder.

FIG. 6 is a graph showing the relation between the coverage of binder and the powder body resistance.

### DESCRIPTION OF EMBODIMENTS

The embodiments in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

A. Electrode

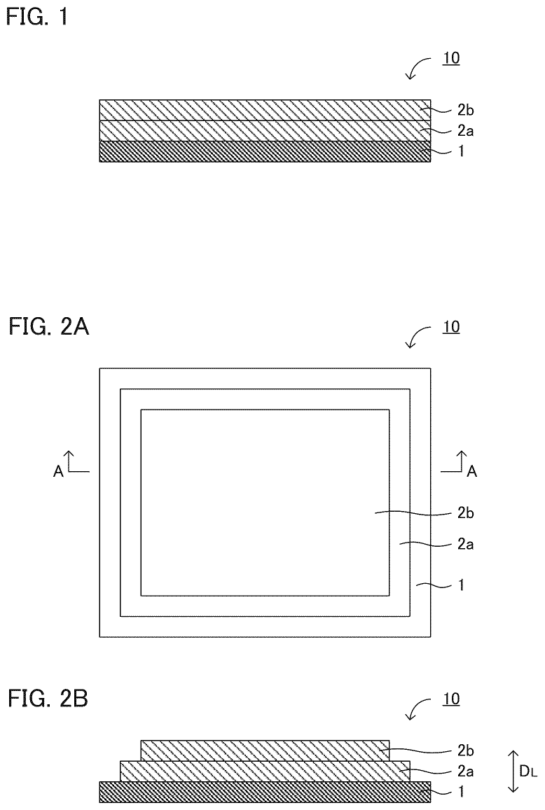

FIG. 1 is an explanatory view explaining the electrode in the present disclosure. Electrode 10 shown in FIG. 1 comprises current collector 1, first electrode layer 2a arranged on the current collector 1, and second electrode layer 2b arranged on the first electrode layer 2a. Also, the first electrode layer 2a includes a first active material, and a first binder covering a surface of the first active material. The second electrode layer 2b includes a second active material, and a second binder covering a surface of the second active material. In the present disclosure, when C₁ (%) designates a coverage of the first binder with respect to the first active material, and C₂ (%) designates a coverage of the second binder with respect to the second active material, the C₁ is larger than the C₂.

According to the present disclosure, when the coverage C₁ of the first binder is larger than the coverage C₂ of the second binder, increase of the resistance increase rate can be inhibited while restraining the degrade of capacity durability during high temperature storage. As described above, the capacity durability may be degraded when the battery is stored under high temperature (such as at 60° C.). This is presumably because a binder in the electrode layer is swelled by the liquid electrolyte during high temperature storage to degrade the bonding force of the electrode layer, and the electron conductivity in the interface between the current collector and the electrode layer is degraded. Meanwhile, when the binder amount in the electrode layer is increased, although the degrade in capacity durability during high temperature storage is suppressed, resistance increase rate during high temperature storage becomes large.

In contrast, in the present disclosure, the coverage C₁ of the first binder in the first electrode layer is relatively high, and thus the peel-off of the current collector and the first electrode layer does not easily occur; as a result, degrade of the capacity durability during high temperature storage is suppressed. At the same time, since the coverage C₂ of the second binder in the second electrode layer is relatively low, increase of the resistance increase rate during high temperature storage is inhibited. In other words, both improvement of the capacity durability and suppression of the resistance increase rate can be achieved.

The coverage C₁ of the first binder with respect to the first active material is, for example, larger than 50%, may be 60% or more, and may be 70% or more. When the coverage C₁ is too small, peel-off of the first electrode layer and the current collector easily occurs. Meanwhile, the coverage C₁ is, for example, 95% or less. When the coverage C₁ is too large, ion conductivity and electron conductivity to the first active material may be inhibited. Details of a method for calculating the coverage will be explained in details in later described Examples. Incidentally, other than a binary code processing described later, for example, the coverage can be obtained by SEM-EDX.

The coverage C₁ of the first binder with respect to the first active material is, for example, larger than 50%, may be 60% or more, and may be 70% or more. When the coverage C₁ is too small, peel-off of the first electrode layer and the current collector easily occurs. Meanwhile, the coverage C₁ is, for example, 95% or less. When the coverage C₁ is too large, ion conductivity and electron conductivity to the first active material may be inhibited.

The coverage C₂ of the second binder with respect to the second active material is, for example, 50% or less, may be 45% or less, and may be 35% or less. When the coverage C₂ is too large, the resistance tends to increase. Meanwhile, the coverage C₂ is, for example, 10% or more, and may be 20% or more. When the coverage C₂ is too small, peel-off of the first electrode layer and the second electrode layer easily occurs.

The difference between the coverage C₁ and the coverage C₂ is, for example, 15% or more, may be 30% or more, and may be 45% or more.

1. First Electrode Layer

The first electrode layer is arranged between the current collector and the second electrode layer. Also, the first electrode layer includes a first active material, and a first binder covering a surface of the first active material.

(1) First Binder

The first electrode layer contains a first binder. The first binder is usually a polymer. Typical examples of the first binder may include polyvinylidene fluoride (PVDF), a polyvinylidene fluoride-polyhexafluoropropylene copolymer (PVDF-HFP), polytetra fluoroethylene (PTFE), and a fluorine-containing binder (fluoride-based binder) such as a fluorine rubber.

In some embodiments, the first binder includes, for example, [—CH₂—CF₂-] (it may be hereinafter referred to as formula 1) as a constituting unit. In some embodiments, the first binder includes a constituting unit represented by the formula 1 as a main body of the constituting unit. “Main body of the constituting unit” means that the ratio (molar ratio) is the most among all the constituting units configuring the binder. The proportion of the constituting unit represented by the formula 1 with respect to all the constituting units configuring the first binder is, for example, 50 mol % or more, may be 70 mol % or more, and may be 90 mol % or more.

The first binder may include, for example, [—C₂F₄-] (hereinafter may be referred to as formula 2) as a constituting unit. Further, the first binder may include the constituting unit represented by the formula 2 as a main body of the constituting unit. The proportion of the constituting unit represented by the formula 2 with respect to all the constituting units configuring the first binder is, for example, 50 mol % or more, may be 70 mol % or more, and may be 90 mol % or more.

The first binder may or may not include [—CF₂CF(CF₃)—] (hereinafter may be referred to as formula 3) as a constituting unit. In the former case, the first binder may include the constituting unit represented by the formula 1 or the formula 2, and the constituting unit represented by the formula 3.

Additional examples of the first binder may include an acrylic resin-based binder such as polyacrylate, polymethylacrylate, polyethylacrylate, polypropylacrylate, polybutylacrylate, polyhexylacrylate, poly2-ethylhexylacrylate, and polydecylacrylate; a methacrylate resin-based binder such as polymethacrylate, polymethylmethacrylate, polyethylmethacrylate, polybutylmethacrylate, and poly2-ethylhexylmethacrylate; an olefin resin-based binder such as polyethylene, polypropylene, and polystyrene; an imide resin-based binder such as polyimide and polyamideimide; an amide resin-based binder such as polyamide; a polycarbonate-based binder such as polyitaconic acid, polyitaconic acid, polyfumaric acid, polyangelic acid, and carboxymethylcellulose; and a rubber-based binder such as a butadiene rubber, a hydride butadiene rubber, a styrene butadiene rubber (SBR), a hydride styrene butadiene rubber, a nitrile butadiene rubber, a hydride nitrile butadiene rubber, and an ethylene propylene rubber.

The degree of swelling of the first binder is, for example, 25% or less, may be 23% or less, and may be 21% or less. In the present disclosure, the degree of swelling of the binder refers to a weight increase rate of a binder alone when it is soaked in a liquid electrolyte at 60° C. for 24 hours. In some embodiments, the liquid electrolyte used for a measurement of the degree of swelling is the same liquid electrolyte as that constitutes the battery. Typically, the liquid electrolyte produced in manners such that EC, DMC, and EMC are mixed in a volume ratio of EC:DMC:EMC=3:4:3 to produce the mixture solvent, and LiPF₆ was dissolved therein so as to be 1 M, can be used. Details of a method for calculating the degree of swelling will be explained in Examples described later.

The melting point of the first binder is, for example, 155° C. or more and may be 160° C. or more. Meanwhile, the melting point of the first binder is, for example, 200° C. or less, may be 180° C. or less, and may be 170° C. or less. The melting point of the binder may be specified by a differential scanning calorimetry (DSC) in conformity to, for example, JIS K 7121.

The first binder is, for example, in a granular shape. The average particle size of the first binder is, for example, 10 nm or more and 1000 nm or less, may be 50 nm or more and 500 nm or less, and may be 100 nm or more and 300 nm or less. In the present disclosure, the average particle size is determined by measuring the particle sizes of target object by SEM observation and calculating the average value thereof. In some embodiments, the number of samples is 100 or more.

The proportion of the first binder in the first electrode layer is not particularly limited, and for example, it is 0.1 weight % or more, may be 0.5 weight % or more, and may be 1 weight % or more. Meanwhile, the proportion is, for example, 15 weight % or less, may be 10 weight % or less, and may be 5 weight % or less.

(2) First Active Material

The first electrode layer contains a first active material. The first active material may be a cathode active material and may be an anode active material.

The first active material is, for example, a lithium-transition metal compound oxide. The lithium-transition metal compound oxide contains Li, M¹ (M¹ is a transition metal of one kind or 2 kinds or more), and O. Examples of the transition metal M¹ may include Ni, Co, Mn, Ti, V, Cr, Fe, Cu, and Zn. In some embodiments, among them the first active material contains at least one kind of Ni, Co, and Mn as a transition metal M¹. A part of the transition metal M¹ may be substituted with a metal (including semimetal) belonging to the 13th to the 17th groups in the periodic table. Typical examples of the metal belonging to the 13th to the 17th groups in the periodic table may include Al.

Specific examples of the first active material may include a rock salt bed type active material such as LiCoO₂, LiMnO₂, LiNiO₂, Li(Ni,Co,Mn)O₂, and Li(Ni,Co,Al)O₂; a spinel type active material such as LiMn₂O₄, Li(Ni_{0.5}Mn_{1.5})O₄, and Li₄Ti₅O₁₂; and an olivine type active material such as LiFePO₄, LiMnPO₄, LiNiPO₄, and LiCoPO₄.

The first active material is, for example, in a granular shape. The average particle size of the first active material is, for example, 1 μm or more and 50 μm or less, may be 2 μm or more and 30 μm or less, and may be 3 μm or more and 10 μm or less. The proportion of the first active material in the first electrode layer is not particularly limited, and for example, it is 40 weight % or more, may be 60 weight % or more and may be 80 weight % or more.

(3) First Electrode Layer

The first electrode layer may further contain a first conductive material. Examples of the first conductive material may include a carbon material. Examples of the carbon material may include a particulate carbon material such as carbon black, and a fiber carbon material such as carbon fiber, carbon nanotube (CNT), and carbon nanofiber (CNF). Examples of the carbon black may include acetylene black(AB), Ketjen black (KB), and furnace black (FB).

The proportion of the first conductive material in the first electrode layer is not particularly limited, and for example, it is 0.5 weight % or more, and may be 1 weight % or more. Meanwhile, the proportion of the first conductive material is, for example, 20 weight % or less, and may be 10 weight % or less. Also, the first electrode layer usually contains a liquid electrolyte described later.

In some embodiments, the first electrode layer contains a first composite body in which the first binder and the first conductive material are dispersed on a surface of the first active material. In the first composite body, in the surface of the first active material, the first conductive material and the first binder are adhered in the dispersed state. In some embodiments, the first electrode layer does not include a material other than the first composite body except for the later described electrolyte. In some embodiments, when the first electrode layer includes a material other than the first composite body (except for the later described electrolyte), the proportion of the material is 5 weight % or less, or 1 weight % or less. Examples of the material other than the first composite body may include an additional conductive material and an additional binder. These materials are the same as the conductive material and the binder described above. Also, the first composite body is usually in a granular shape.

The thickness of the first electrode layer is, for example, 1 μm or more and 500 μm or less, may be 5 μm or more and 250 μm or less, and may be 15 μm or more and 150 μm or less.

2. Second Electrode Layer

The second electrode layer is arranged in a surface of the first electrode layer that is opposite side to the current collector. Also, the second electrode layer includes a second active material, and a second binder covering a surface of the second active material.

(1) Second Binder

The second electrode layer contains a second binder. The second binder is usually a polymer. Details of the second binder are the same as the first binder described above; thus the descriptions herein are omitted.

The second binder and the first binder may have the same composition, and may have different compositions. In some embodiments, among them the second binder and the first binder may have the same composition. Since the degrees of swelling of the second binder and the first binder are the same, when they are swelled by the liquid electrolyte, stress is not easily generated between the second electrode layer and the first electrode layer.

The proportion of the second binder in the second electrode layer is not particularly limited, and for example, it is 0.1 weight % or more, may be 0.5 weight % or more, and may be 1 weight % or more. Meanwhile, the proportion is, for example, 15 weight % or less, may be 10 weight % or less, and may be 5 weight % or less. In some embodiments, the proportion B₂ (weight %) of the second binder in the second electrode layer is the same as the proportion B₁ (weight %) of the first binder in the first electrode layer. “The proportion B₂ and the proportion B₁ being the same” means that the absolute value of the difference between the both is 0.5 weight % or less. Meanwhile, the proportion B₂ may be larger than the proportion B₁, and may be smaller than the proportion B₁.

(2) Second Active Material

The second electrode layer contains a second active material. The second active material may be a cathode active material and may be an anode active material. Also, the second active material and the first active material usually work as an active material having the same polarity. Details of the second active material are the same as the first active material described above; thus the descriptions herein are omitted.

The second active material and the first active material may have the same composition, and may have different compositions. In some embodiments, among them the second active material and the first active material may have the same composition. The reason therefor is because the charge and discharge behavior are the same, and voltage control may become easy.

The proportion of the second active material in the second electrode layer is not particularly limited, and for example, it is 40 weight % or more, may be 60 weight % or more and may be 80 weight % or more. In some embodiments, proportion A₂ (weight %) of the second active material in the second electrode layer is the same as proportion A₁ (weight %) of the first active material in the first electrode layer. The proportion A₂ and the proportion A₁ being the same means that the absolute value of the difference between the both is 5 weight % or less. Meanwhile, the proportion A₂ may be larger than the proportion A₁, and may be smaller than the proportion A₁.

(3) Second Electrode Layer

The second electrode layer may further contain a second conductive material. Details of the second conductive material are the same as the first conductive material described above; thus the descriptions herein are omitted.

The proportion of the second conductive material in the second electrode layer is not particularly limited, and for example, it is 0.5 weight % or more, and may be 1 weight % or more. Meanwhile, the proportion of the second conductive material is, for example, 20 weight % or less, and may be 10 weight % or less. In some embodiments, the proportion E₂ (weight %) of the second conductive material in the second electrode layer is the same as the proportion E₁ (weight %) of the first conductive material in the first electrode layer. The proportion E₂ and the proportion E₁ being the same means that the absolute value of the difference between the both is 0.5 weight % or less. Meanwhile, the proportion E₂ may be larger than the proportion E₁, and may be smaller than the proportion E₁. Also, the second electrode layer usually contains a liquid electrolyte described later.

In some embodiments, the second electrode layer contains a second composite body in which the second binder and the second conductive material are dispersed on a surface of the second active material. In the second composite body, in the surface of the second active material, the second conductive material and the second binder are adhered in the dispersed state. In some embodiments, the second electrode layer does not include a material other than the second composite body except for the electrolyte described later. In some embodiments, when the second electrode layer includes a material other than the second composite body (except for later described electrolyte), the proportion of the material is 5 weight % or less, or 1 weight % or less. Examples of the material other than the second composite body may include an additional conductive material and an additional binder. Also, the second composite body is usually in a granular shape.

The thickness of the first electrode layer is, for example, 1 μm or more and 500 μm or less, may be 5 μm or more and 250 μm or less, and may be 15 μm or more and 150 μm or less.

There are not particular limitations on the relation between the thickness of the second electrode layer and the thickness of the first electrode layer. The thickness of the second electrode layer may be larger than the thickness of the first electrode layer, may be the same as the thickness of the first electrode layer, and may be smaller than the thickness of the first electrode layer. “The thickness of the second electrode layer and the thickness of the first electrode layer being the same” means that the absolute value of the difference of the thickness between the both is 3 μm or less.

T₁ designates the thickness of the first electrode layer, and T₂ designates the thickness of the second electrode layer. The rate of T₁ with respect to the total of T₁ and T₂, which is T₁/(T₁+T₂) is, for example, 30% or more, may be 40% or more, and may be 45% or more. Within the above range, degrade of the capacity durability during high temperature storage can be further inhibited. The rate T₁/(T₁+T₂) is, for example, 70% or less, may be 60% or less, and may be 55% or less. Within the above range, increase of the resistance increase rate during high temperature storage can be further suppressed.

3. Current Collector

The current collector in the present disclosure collects currents of the first electrode layer and the second electrode layer. The current collector may be a cathode current collector, and may be an anode current collector. Examples of the material for the cathode current collector may include SUS, aluminum, nickel, iron, titanium, and carbon. Examples of the material for the anode current collector may include SUS, copper, nickel, and carbon. Also, examples of the shape of the current collector may include a foil shape and a mesh shape.

4. Electrode

The electrode in the present disclosure includes layers in the order of a current collector, a first electrode layer and a second electrode layer in the thickness direction. Also, the electrode in the present disclosure is used for a battery. FIG. 2A is a schematic plan view exemplifying the electrode in the present disclosure, and FIG. 2B is a cross-sectional view of A-A in FIG. 2A. As shown in FIGS. 2A and 2B, in a plan view observed from layered direction D L of the electrode 10, in some embodiments, the area of the current collector 1 is larger than the area of the first electrode layer 2a. In some embodiments, the area of the first electrode layer 2a is larger than the area of the second electrode layer 2b. In other words, when viewed from the layered direction DL of the electrode 10, and S₀ designates the area of the current collector 1, S₁ designates the area of the first electrode layer 2a, and S₂ designates the area of the second electrode layer 2b, and in some embodiments, it is S₀>S₁>S₂.

As shown in FIGS. 2A and 2B, when viewed from the layered direction DL of the electrode 10, in some embodiments, the entire outer periphery of the first electrode layer 2a is inside the entire outer periphery of the current collector 1 (positional relation A). In the same manner, in some embodiments, when viewed from the layered direction DL of the electrode 10, the entire outer periphery of the second electrode layer 2b is inside the entire outer periphery of the first electrode layer 2a (positional relation B). On the occasion of pressing the current collector, the first electrode layer and the second electrode layer, when viewed from the layered direction of the electrode, pressure tends to escape in the boundary between the current collector and the first electrode layer, as well as in the boundary between the first electrode layer and the second electrode layer, and peel-off easily occurs when the binder is swelled. In contrast, by satisfying the positional relation A and the positional relation B, the pressure does not easily escape, and thus peel-off will not easily occur when the binder is swelled. As a result, the capacity durability improves.

B. Battery

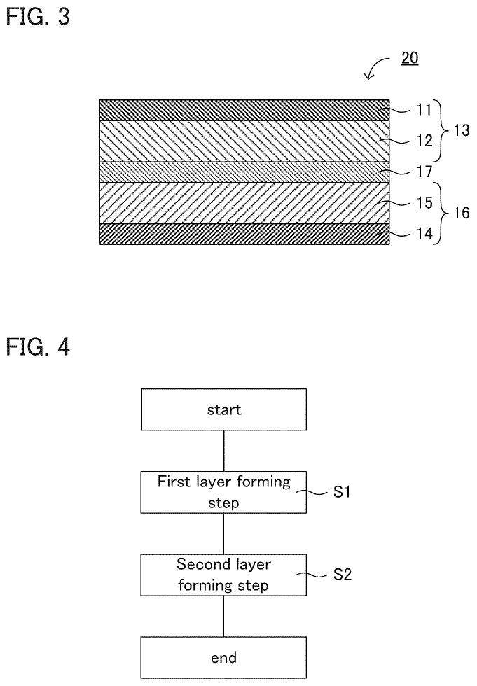

FIG. 3 is a schematic cross-sectional view exemplifying the battery in the present disclosure. Battery 20 shown in FIG. 3 includes cathode 13 including cathode current collector 11 and cathode layer 12, anode 16 including anode current collector 14 and anode layer 15, and electrolyte layer 17 arranged between the cathode 13 and the anode 16. At least one of the cathode 13 and the anode 16 corresponds to the electrode described in “A. Electrode” above.

According to the present disclosure, at least one of the cathode and the anode is the above described electrode, and thus the increase of resistance increase rate is inhibited while restraining the degrade of capacity durability during high temperature storage.

1. Cathode

The cathode includes a cathode current collector and a cathode layer positioned in a surface of the cathode current collector that is the electrode layer side. In some embodiments, the cathode in the present disclosure corresponds to the electrode described above. Meanwhile, when the cathode in the present disclosure does not correspond to the electrode described above, usually, the anode in the present disclosure corresponds to the electrode described above. In this case, a conventional arbitrary cathode can be used as the cathode.

2. Anode

An anode includes an anode current collector, and an anode layer positioned in a surface of the anode current collector that is the electrode layer side. In some embodiments, the anode in the present disclosure corresponds to the electrode described above. Meanwhile, when the anode in the present disclosure does not correspond to the electrode described above, usually, the cathode in the present disclosure corresponds to the electrode described above. In this case, a conventional arbitrary anode can be used as the anode.

3. Electrolyte Layer

The electrolyte layer in the present disclosure contains at least an electrolyte. Examples of the electrolyte may include an electrolyte solution (liquid electrolyte) and a gel electrolyte.

The liquid electrolyte contains, for example, a lithium salt and a solvent. Examples of the lithium salt may include an inorganic lithium salt such as LiPF₆, LiBF₄, LiClO₄ and LiAsF₆; and an organic lithium salt such as LiCF₃SO₃, LiN(SO₂CF₃)₂, LiN(SO₂C₂F₅)₂, and LiC(SO₂CF₃)₃. Examples of the solvent may include ethylene carbonate (EC), propylene carbonate (PC), butylene carbonate (BC), dimethyl carbonate (DMC), diethyl carbonate (DEC), and ethyl methyl carbonate (EMC). The solvent may be just one kind, and may be two kinds or more.

The gel electrolyte is usually obtained by adding a polymer to a liquid electrolyte. Examples of the polyether may include a polyethylene oxide, and a polypropylene oxide. The thickness of the electrolyte layer is, for example, 0.1 μm or more and 1000 μm or less. The electrolyte layer may include a separator.

4. Battery

The battery in the present disclosure is typically a lithium ion secondary battery. Examples of the applications of the battery in the present disclosure may include a power source for vehicles such as hybrid electric vehicles (HEV), plug-in hybrid electric vehicles (PHEV), battery electric vehicles (BEV), gasoline-fueled automobiles and diesel powered automobiles. In some embodiments, the battery in the present disclosure is a power source for driving vehicles. Also, the battery in the present disclosure may be used as a power source for moving bodies other than vehicles (such as rail road transportation, vessel and airplane), and may be used as a power source for electronic products such as information processing equipment.

C. Method for Producing Electrode

FIG. 4 is a flow-chart exemplifying the method for producing the electrode in the present disclosure. First, a first electrode layer is formed on a current collector using a first electrode mixture containing a first active material and a first binder covering a surface of the first active material, by a dry method (first layer forming step; S1). Next, a second electrode layer is formed on the first electrode layer using a second electrode mixture containing a second active material and a second binder covering a surface of the second active material, by a dry method (second layer forming step; S₂). The coverage C₁ of the first binder with respect to the first active material is larger than the coverage C₂ of the second binder with respect to the second active material.

1. First Layer Forming Step

The first layer forming step in the present disclosure is a step of forming a first electrode layer on the current collector, using a first electrode mixture containing a first active material and a first binder covering a surface of the first active material, by a dry method. In the present disclosure, the dry method refers to a method for forming an electrode layer without using a dispersion medium such as an organic solvent.

The first electrode mixture contains a first active material, and a first binder covering a surface of the first active material. In some embodiments, the first electrode mixture further contains a first conductive material. In some embodiments, the first electrode mixture contains a first composite body in which the first binder and the first conductive material are dispersed on a surface of the first active material.

Examples of the method for producing the first composite body may include a method of compounding the first active material, the first binder, and the first conductive material using a compounding treatment device. In some embodiments, the compounding treatment is performed by a dry method. Examples of the compounding treatment device may include a mixer, a bead mill, a ball mill, and a mortar. In the case of the compounding treatment using a mixer, the revolving number during compounding (applying load) may be, for example, 500 rpm or more and 20000 rpm or less, and may be 1000 rpm or more and 10,000 rpm or less. Also, the treatment time is, for example, 30 seconds or more and 2 hours or less, may be 1 minute or more and 1 hour or less, and may be 1 minute or more and 30 minutes or less.

In some embodiments, the first electrode mixture does not include a material other than the first composite body. In some embodiments, when the first electrode mixture includes a material other than the first composite body, the proportion of the material is 5 weight % or less, or 1 weight % or less. Examples of the material other than the first composite body may include an additional conductive material and an additional binder. The additional conductive material and the additional binder are in the same contents as those described in “A. Electrode” above.

In the present disclosure, the first electrode layer is formed on the current collector using the first electrode mixture by a dry method. Forming the first electrode layer by a dry method allows reduction of drying time and reduction of amount of usage of an organic solvent. Examples of the dry method may include an electrostatic layer forming method such as an electrostatic screen layer forming. After forming the first electrode layer on the current collector, as required, heating may be performed to improve the adhesiveness, and pressurizing may be performed to improve mixture density. The current collector is in the same contents as those described in “A. electrode” above.

2. Second Layer Forming Step

The second layer forming step in the present disclosure is a step of forming a second electrode layer on the first electrode layer, using a second electrode mixture containing a second active material and a second binder covering a surface of the second active material, by a dry method.

The second electrode layer contains a second active material, and a second binder covering a surface of the second active material. In some embodiments, the second electrode mixture further contains a second conductive material. In some embodiments, the second electrode mixture contains a second composite body in which the second binder and the second conductive material are dispersed on a surface of the second active material. The method for producing the second composite body and is the same as the method for producing the first composite body described above.

In some embodiments, the second electrode mixture does not include a material other than the second composite body. In some embodiments, when the second electrode mixture include a material other than the second composite body, the proportion of the material is 5 weight % or less, or 1 weight % or less. Examples of the material other than the second composite body may include an additional conductive material and an additional binder. The additional conductive material and the additional binder are in the same contents as those described in “A. Electrode” above.

In the present disclosure, the second electrode layer is formed on the first electrode layer using the second electrode mixture by a dry method. Forming the second electrode layer by a dry method allows reduction of drying time and reduction of amount of usage of an organic solvent. Examples of the dry method may include an electrostatic layer forming method such as an electrostatic screen layer forming. After forming the second electrode layer on the first electrode layer, as required, heating may be performed to improve the adhesiveness, and pressurizing may be performed to improve mixture density.

3. Electrode

The electrode obtained by the above described first layer forming step and the second layer forming step is in the same contents as those described in “A. Electrode” above.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Comparative Example 1

First, a cathode active material (NCM, particle size of 3 to 10 μm from Sumitomo Metal Mining Co., Ltd.), a conductive material (acetylene black, Li400 from Denka Company Limited.), and a binder (#7300, polyvinylidene fluoride from KUREHA CORPORATION) were weighed so as to be in the ratio of the cathode active material:the conductive material:the binder=97.5/1.5/1 (wt %), and mixed. A dispersion medium was added to the obtained mixture and agitated to obtain a cathode slurry. The obtained cathode slurry was pasted on a cathode current collector (aluminum foil of 12 μm thickness) by a film applicator, and then dried at 80° C. for 5 minutes. Thereby, a cathode structure body including a cathode current collector and a cathode layer was obtained.

Next, an anode active material (natural graphite) and a binder (SBR and CMC) were mixed, and then a dispersion medium was added to the obtained mixture and agitated to obtain an anode slurry. The obtained anode slurry was pasted on an anode current collector by a film applicator, and then dried at 80° C. for 5 minutes. Thereby, an anode structure body including an anode current collector and an anode layer was obtained.

The cathode layer in the cathode structure body and the anode layer in the anode structure body were faced to each other interposing a separator, winded, and a liquid electrolyte was injected to obtain an evaluation cell. The used liquid electrolyte was produced in manners such that, EC, DMC, and EMC were mixed in a volume ratio of EC:DMC:EMC=3:4:3 to produce the mixture solvent, and LiPF₆ was dissolved therein so as to be 1 M.

### Comparative Example 2

(1) Compounding Cathode Materials

First, a cathode active material (NCM, particle size of 3 to 10 μm from Sumitomo Metal Mining Co., Ltd.), a conductive material (acetylene black, Li400 from Denka Company Limited.), and a binder (HSV1810, polyvinylidene fluoride, particle size of 150 nm from ARKEMA) were weighed so as to be the cathode active material:the conductive material:the binder=97.5:1.5:1 (wt %), projected into an MP mixer from NIPPON COKE & ENGINEERING. CO., LTD., agitated in the conditions of 10,000 rpm and 10 minutes to perform a compounding treatment, and thereby a composite body (composite body A) was obtained.

(2) Forming Layer

The obtained composite body was pasted on a current collector (aluminum foil having the thickness of 12 μm) using an electrostatic screen forming machine (from Berg Co., Ltd.) by a dry method. On this occasion, the voltage was 1.5 kV, and the distance from the current collector to the screen was 1 cm.

(3) Fixation

The binder was softened (melted) by applying the load of 5 t for 1 minute with a flat plate of which up and down surfaces were heated to 180° C., and the composite body was fixed on the current collector to produce a cathode structure body including the cathode current collector and the cathode layer.

(4) Production of Evaluation Cell

An evaluation cell was obtained in the same manner as in Comparative Example 1 except that the obtained cathode structure body was used.

### Comparative Example 3

A composite body (composite body B) was obtained in the same manner as in Comparative Example 2 except that the agitating time of the compounding treatment was changed to 60 minutes. An evaluation cell was obtained in the same manner as in Comparative Example 2 except that the obtained composite body was used.

### Example 1

A composite body A was prepared in the same manner as in Comparative Example 2, and a composite body B was prepared in the same manner as in Comparative Example 3. The obtained composite body B was pasted on a current collector (aluminum foil having the thickness of 12 μm) using an electrostatic screen forming machine (from Berg Co., Ltd.) by a dry method to form a first electrode layer (lower layer). On this occasion, the voltage was 1.5 kV, and the distance from the current collector to the screen was 1 cm. Next, the composite body A was pasted on the first electrode layer by the dry method in the same conditions, and thereby a second electrode layer (upper layer) was formed.

After that, the binder was softened (melted) by applying the load of 5 t for 1 minute with a flat plate of which up and down surfaces were heated to 180° C., and the composite body A was fixed on the current collector to produce a cathode structure body including the cathode current collector, a first cathode layer (first electrode layer) formed on the cathode current collector, and a second cathode layer (second electrode layer) formed on the first cathode layer. An evaluation cell was obtained in the same manner as in Comparative Example 1 except that the obtained cathode structure body was used.

[Evaluation]
(1) Degree of Swelling

The degree of swelling of the binders used in Comparative Example 1 (wet method) and Comparative Example 2 (dry method) were measured. In specific, the weight of the binder (weight of the binder before soaking) processed into a sheet shape was measured, and then soaked for 24 hours in a liquid electrolyte at 60° C. (the liquid electrolyte produced in manners such that EC, DMC, and EMC were mixed in a volume ratio of EC:DMC:EMC=3:4:3 to produce the mixture solvent, and LiPF₆ was dissolved therein so as to be 1 M). Next, the weight of the binder (weight of the binder after soaking) taken out from the liquid electrolyte was measured and the degree of swelling was obtained from the below formula:

Degree of swelling of binder (%)=((Weight of binder after soaking)−(Weight of binder before soaking))/(Weight of binder before soaking)*100.

As a result, the degree of swelling of the binder used in Comparative Example 1 (wet method) was 15%, and the degree of swelling of the binder used in Example 1 (dry method) was 21%.

(2) Melting Point

The melting point of the binders used in Comparative Example 1 (wet method) and Comparative Example 2 (dry method) were measured. In specific, it was obtained by differential scanning calorimetry (DSC) in conformity to JIS K 7121. As a result, the melting point of the binder used in Comparative Example 1 (wet method) was 173° C., and the melting point of the binder used in Comparative Example 2 (dry method) was 167° C.

(3) Coverage

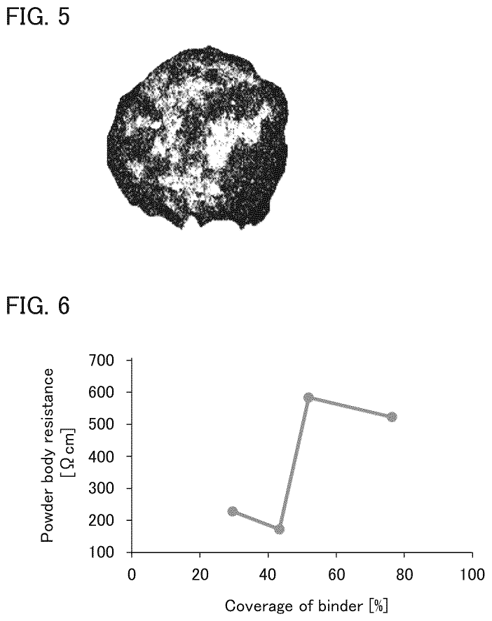

The composite bodies obtained in Comparative Examples 2 and 3 were observed by SEM (Scanning Electron Microscope), a binary code processing was performed thereto, and thereby the coverages of the binders were calculated. In specific, as shown in FIG. 5, the composite bodies were observed by SEM, and then a binary code processing was performed. In the binary code processing, a binary processing method by Otsu was used to set threshold. Since the conductive material (acetylene black) is adhered to a part covered by the binder in the surface of the active material, in the image after the binary code processing, the proportion of black color with respect to whole was defined as the coverage of the binder. The results are shown in Table 1.

(4) Capacity Durability

Regarding the evaluation cells obtained in Comparative Examples 1 to 3 and Example 1, the capacity durability before and after the high temperature test was respectively obtained. In specific, the evaluation cells were charged and discharged, and the capacities (initial capacities) were obtained. Next, the evaluation cells were stored in a thermostatic tank at 60° C. for 10 days, and the capacities of the evaluation cells (capacities after storage) were measured in the same manner. The capacity durability was obtained from the below formula. The results are shown in Table 1.

Capacity durability (%)=(capacity after storage/initial capacity)*100

(5) Resistance Increase Rate

Regarding the evaluation cells obtained in Comparative Examples 1 to 3 and Example 1, the resistance increase rates before and after the high temperature test were obtained. In specific, the evaluation cells were charged and then discharged for 10 seconds at the current I of 0.3 C, 0.5 C, and 1 C respectively, and the voltage decrease amounts ΔV in 10 seconds were measured. The IV resistances (initial resistance) of the evaluation cells were obtained from the relation between the current I and ΔV. Next, evaluation cells were stored in a thermostatic tank at 60° C. for 10 days, and the IV resistance (resistance after storage) was respectively obtained in the same manner. The resistance increase rates were obtained from the below formula. The results are shown in Table 1.

Resistance increase rate (%)=(Resistance after storage/Initial storage)*100

TABLE 1

| | Electrode layer | | Coverage | Capacity | Resistance |
|---|---|---|---|---|---|
| | | Thickness | of binder | durability | increase rate |
| | Structure | [μm] | [%] | [%] | [%] |
| Comp. Ex. 1 | Wet_Single layer | 100 | — | 96.8 | 1.3 |
| Comp. Ex. 2 | Dry_Single layer | 100 | 29.8 | 95.8 | 1.01 |
| Comp. Ex. 3 | Dry_Single layer | 100 | 76.6 | 97.8 | 1.5 |
| Example 1 | Dry_Two layers | 50/50 | upper layer: 29.8/ | 97.0 | 1.1 |
| | | | lower layer: 76.6 | | |

As shown in Table 1, Comparative Example 2 had lower capacity durability compared to Comparative Example 1, but the decrease in resistance increase rate was confirmed. To improve the coverage, the binder used in Comparative Example 2 (dry method) had lower melting point (higher degree of swelling) than that of the binder used in Comparative Example 1 (wet method). For this reason, Comparative Example 2 was more easily affected by the binder swelling due to the liquid electrolyte compared to Comparative Example 1, and thereby it is considered that the capacity durability became lower than that of Comparative Example 1. On the other hand, the compounding treatment was performed in Comparative Example 2, and thus the coverage of the binder in Comparative Example 2 was higher than the coverage of the binder in Comparative Example 1. Thereby, it is considered that the resistance increase due to the binder swelling was suppressed.

As shown in Table 1, Comparative Example 3 had higher capacity durability compared to Comparative Example 2, but increase of the resistance increase rate was confirmed. Since the coverage of the binder in Comparative Example 3 was higher than that of Comparative Example 2, the bonding force in the electrode layer was high. For this reason, also after the binder swelling due to the liquid electrolyte, the bonding force was maintained, and thereby it is considered that the capacity durability became high. On the other hand, since the coverage of the binder in Comparative Example 3 was higher than that of Comparative Example 2, it is considered that the resistance increase rate during high temperatures storage (during binder swelling) increased.

In contrast, as shown in Table 1, the capacity durability of Example 1 was higher than that of Comparative Example 2, and the resistance increase rate of Example 1 was lower than that of Comparative Example 3. In other words, both the improvement of the capacity durability and the suppression of the resistance increase rate were achieved. It is presumed that the coverage of the binder in the first electrode layer (lower layer) was relatively high, and thus the peel-off of the first electrode layer and the current collector did not easily occur; as a result, the improvement of the capacity durability was achieved. At the same time, it is presumed that the coverage of the binder in the second electrode layer (upper layer) was relatively low, and thus the resistance increase rate was suppressed during high temperature storage (during binder swelling).

### Reference Example

Four composite bodies (composite bodies A to D) with different coverages were produced by adjusting the agitating time in the compounding treatment. Incidentally, the composite bodies A and B were respectively the same as the composite bodies A and B produced in Comparative Examples 2 and 3 described above. The powder body resistances of the obtained composite bodies A to D were measured by an automatic powder body resistance measurement system, low resistance version MCP-PD600. The results are shown in FIG. 6. As shown in FIG. 6, it was confirmed that the powder body resistance was drastically decreased when the coverage of the binder became 50% or less. For this reason, in some embodiments, it was confirmed that the coverage C₂ of the second binder with respect to the second active material is 50% or less.

### REFERENCE SIGNS LIST

1 current collector
2a first electrode layer
2b second electrode layer
10 electrode
11 cathode current collector
12 cathode layer
13 cathode
14 anode current collector
15 anode layer
16 anode
17 electrolyte layer
20 battery

What is claimed is:

1. An electrode to be used for a battery, the electrode comprising:
a current collector, a first electrode layer arranged on the current collector, and a second electrode layer arranged on the first electrode layer, wherein
the first electrode layer includes a first active material, and a first binder covering a surface of the first active material;
the second electrode layer includes a second active material, and a second binder covering a surface of the second active material; and
when C₁ (%) designates a coverage of the first binder with respect to the first active material, and C₂ (%) designates a coverage of the second binder with respect to the second active material, the C₁ is larger than the C₂.

2. The electrode according to claim 1, wherein the C₁ is larger than 50%, and the C₂ is 50% or less.

3. The electrode according to claim 1, wherein a difference between the C₁ and the C₂ is 30% or more.

4. The electrode according to claim 1, wherein the first binder and the second binder are a fluorine-containing binder.

5. The electrode according to claim 1, wherein the first binder and the second binder have the same composition.

6. The electrode according to claim 1, wherein the first active material and the second active material are a lithium transition metal composite oxide.

7. The electrode according to claim 1, wherein the first active material and the second active material have the same composition.

8. The electrode according to claim 1, wherein
the first electrode layer contains a first composite body in which the first binder and a first conductive material are dispersed on a surface of the first active material; and
the second electrode layer contains a second composite body in which the second binder and a second conductive material are dispersed on a surface of the second active material.

9. A battery including a cathode, an anode, and an electrolyte layer arranged between the cathode and the anode, wherein
at least one of the cathode and the anode is the electrode according to claim 1.

10. The battery according to claim 9, wherein the battery is a lithium ion battery.

11. A method for producing an electrode to be used for a battery, the method comprising:
a first layer forming step of forming a first electrode layer on a current collector, using a first electrode mixture containing a first active material and a first binder covering a surface of the first active material, by a dry method; and
a second layer forming step of forming a second electrode layer on the first electrode layer, using a second electrode mixture containing a second active material and a second binder covering a surface of the second active material, by a dry method; and
when C₁ (%) designates a coverage of the first binder with respect to the first active material, and C₂ (%) designates a coverage of the second binder with respect to the second active material, the C₁ is larger than the C₂.
